(19) United States
(12) Patent Application Publication
(10) Pub. No.: US 2008/0152351 A1
(43) Pub. Date: Jun. 26, 2008

(54) Data communication using solitons

(76) Inventor: Eric C. Hannah, Pebble Beach, CA (US)

Correspondence Address: BUCKLEY, MASCHOFF & TALWALKAR LLC, 50 LOCUST AVENUE, NEW CANAAN, CT, 06840, US

(21) Appl. No.: 11/645,381

(22) Filed: Dec. 26, 2006

(51) Int. Cl. H04B 10/12

(52) U.S. Cl. 398/146

(57) ABSTRACT

A system may include a transmission circuit to selectively generate a first soliton-based signal or a second soliton-based signal and a receiver. The receiver may receive a first signal from the transmission circuit, determine whether the first signal comprises the first soliton-based signal or the second soliton-based signal, and determine a data value based on whether the received signal comprises the first soliton-based signal or the second soliton-based signal. The first soliton-based signal may comprise a soliton, and the second soliton-based signal may comprise a solitonic molecule.

### BACKGROUND

Typical electronic systems such as computing platforms include various electronic components mounted on substrates. Such substrates provide physical support to the electronic components and include interconnects over which the electronic components may communicate with one another. The speed of such communication is limited due to signal attenuation and dispersion within the substrate. These and other loss and phase-shifting mechanisms reduce the duration of the periodic time window during which a receiver is able to reliably detect a transmitted voltage (e.g., representing a binary “1” or “0”). At communication speeds above a certain threshold, this time window shrinks to a point at which data cannot be reliably detected.

Solitons have been proposed to address the foregoing. Solitons are waveforms which naturally resist the distorting effects of loss and dispersion within conventional interconnects. As described above, conventional signaling systems may interpret the presence of a pulse within a particular periodic time window as a binary “1” and the absence of a pulse (when one is expected) as a binary “0”. However, variances in the propagation speed of successive solitons may result in significant jitter in their arrival time at a receiver. Accordingly, it is difficult to ensure the presence of a soliton at a receiver within the particular periodic time window when a “1” is desired and an absence of a soliton when a “0” is desired.

### BRIEF DESCRIPTION OF THE DRAWINGS

FIG. 1 is a block diagram illustrating a system according to some embodiments.

FIGS. 2A and 2B illustrate soliton-based signals according to some embodiments.

FIGS. 3A through 3C illustrate non-linear transmission lines according to some embodiments.

FIG. 4 is a flow diagram of a process according to some embodiments.

FIG. 5 is a block diagram of a system according to some embodiments.

### DETAILED DESCRIPTION

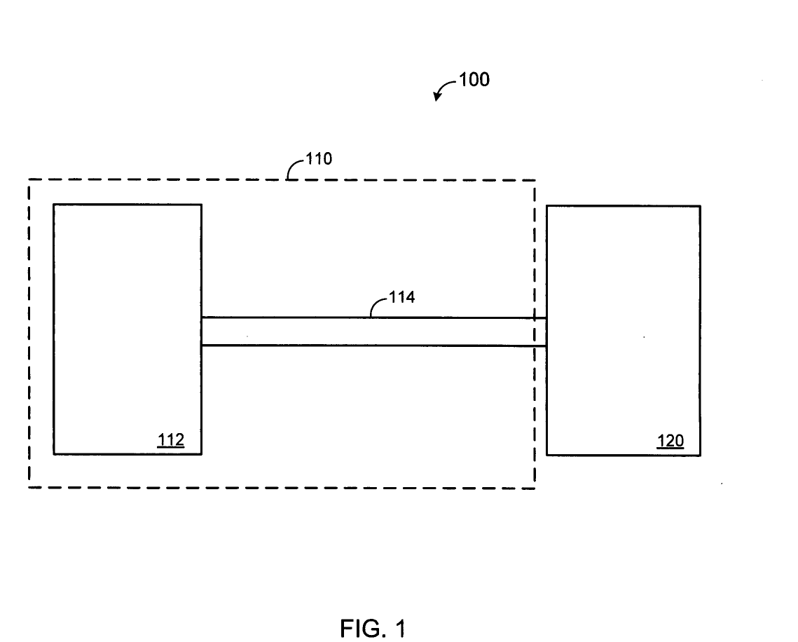

FIG. 1 illustrates system 100 according to some embodiments. System 100 comprises transmission circuit 110 and receiver 120. Transmission circuit 110, in turn, comprises transmitter 112 and transmission line 114. In some embodiments, transmitter 112 and receiver 120 may be elements of respective integrated circuit dice, and transmission line 114 may comprise a component of a motherboard to which the dice are mounted. In this regard, system 100 may comprise a server platform according to some embodiments.

Transmission circuit 110 may operate to selectively generate a first soliton-based signal or a second soliton-based signal. Receiver 120 may receive a first signal from transmission circuit 110 and may determine whether the first signal comprises the first soliton-based signal or the second soliton-based signal. Moreover, receiver 120 may determine a data value based on whether the received signal comprises the first soliton-based signal or the second soliton-based signal. In some embodiments, the first soliton-based signal is a first symbol that may be used to asynchronously represent a first data value and the second soliton-based signal is a second symbol that may be used to asynchronously represent a second data value.

In some embodiments, transmission circuit 110 generates the aforementioned signals using nonlinear transmission line 114. Generally, a short length of non-linear transmission line may sharpen the leading and trailing edges of bit patterns transmitted thereby. Specifically, the large voltage rise of a pulse edge decreases the line's capacitance and thereby increases the propagation speed of the pulse. In a non-linear transmission line of suitable length and/or other characteristics, all pulses merge into a unique and stable soliton waveform.

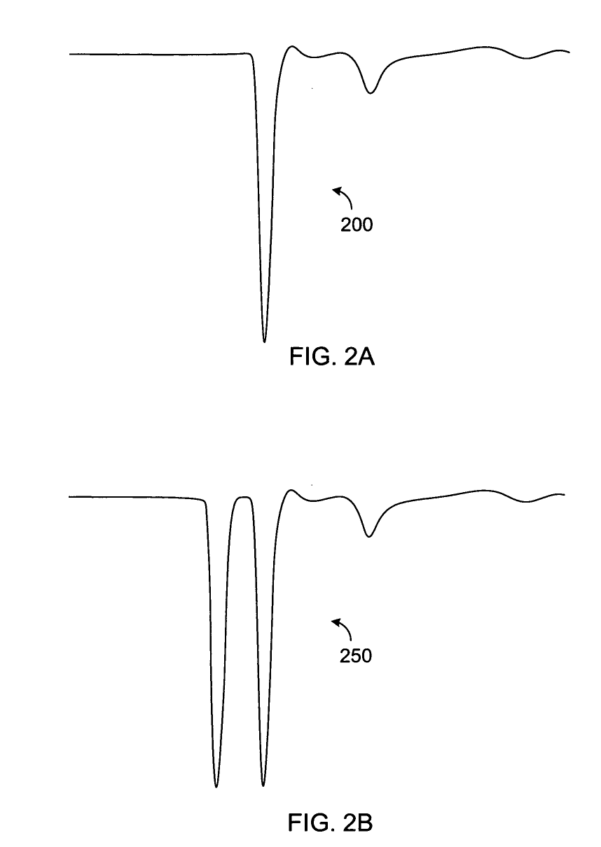

FIG. 2A illustrates soliton 200 according to some embodiments. Soliton 200 may represent a first soliton-based signal generated by transmission circuit 110. Any suitable voltage range, duration, and/or frequency of soliton 200 may be employed according to some embodiments. These characteristics may depend at least on a desired communication speed, characteristics of transmission line 114, and operating parameters of transmitter 112 and receiver 120.

Soliton-based signal 250 may comprise a weak binding of solitons called a “solitonic molecule”. A solitonic molecule may be generated by transmitting two solitons over a non-linear transmission line. The first soliton increases its internal speed of propagation by impressing a large voltage on the underlying nonlinearities of the transmission line. If these nonlinearities do not recover their low voltage capacitance immediately after the passage of the first soliton, then the second soliton propagates faster than the first soliton. The second soliton eventually approaches the first soliton and they will begin to interact by the effect of their combined waveforms on the nonlinearities. A double-sized soliton is not a solution of the nonlinear system, so the two solitons will remain separated but bonded together, and will be substantially stable against modest perturbations. This thusly-bonded is different from two close-by solitons and may be referred to as a solitonic molecule. A solitonic molecule may comprise two “bright” solitons connected by a “dark” soliton.

Of course, transmission circuit 110 may generate a second soliton-based signal different from the above-described solitonic molecule. Different implementations of non-linear transmission line 114, for example, may result in more complex molecules. Some embodiments seek to generate soliton-based signals having a shortest transmission time.

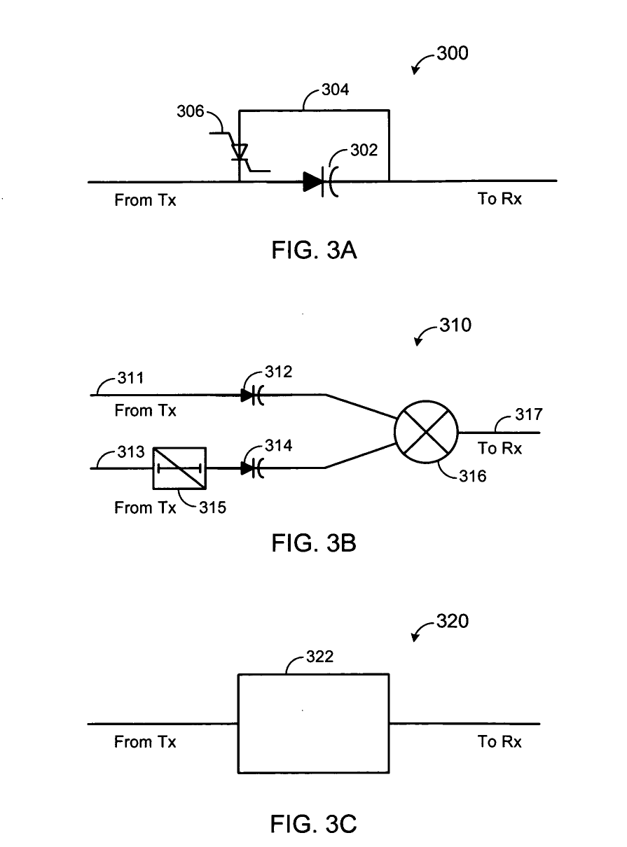

FIGS. 3A through 3C illustrate various implementations of a non-linear transmission line according to some embodiments. The illustrated transmission lines may operate as described above with respect to transmission line 114. The transmission lines are illustrated schematically, and may be implemented using any suitable hardware and/or software arrangement that is or becomes known.

Transmission line 300 of FIG. 3A includes varactor 302 and signal line 304 including switch 306. A capacitance of varactor 302 decreases as the voltage across varactor 302 increases. Transmission line 300 may include several instances of varactor 302 and signal line 304 in some embodiments.

Signal line 304 creates a time-delay memory for varactor 302. In some embodiments, varactor 302 increases its capacitance (thus slowing down propagation of a signal on line 300) immediately after passing a soliton, and then decreases its capacitance for a time period (thereby speeding up propagation of a subsequently-received signal) before returning to equilibrium. Such operation may create a natural dark soliton between two bright solitons and a binding potential for the second bright soliton that defines the extent of the resulting solitonic molecule.

Accordingly, switch 306 of signal line 304 may selectively disconnect the input of varactor 302 from the output in order to transmit a single soliton or may connect the input to the output in order to transmit a solitonic molecule. As mentioned above, the single soliton may represent a first data value and the second solitonic molecule may represent a second data value. Switch 306 may be controlled by a transmitter such as transmitter 112. In other words, the transmitter may open switch 306 and transmit a single soliton-resulting pulse in order to transmit a first data value, and may close switch 306 and transmit the single soliton-resulting pulse in order to transmit a second data value.

Transmission line 310 of FIG. 3B also may operate to selectively generate a first and a second soliton-based signal. Transmission line 310 includes non-linear transmission line 311 and non-linear transmission line 313. Lines 311 and 313 are non-linear by virtue of respective varactors 312 and 314. Lines 311 and 313 may include additional varactors in some embodiments.

Transmission line 313 also includes delay element 315. Delay element 315 may comprise an element of a transmitter to which transmission line 313 is coupled. In operation, a transmitter may transmit a soliton-resulting signal to each of transmission lines 311 and 313 substantially simultaneously. Such operation may involve deactivating delay element 315. Circuit 316 then receives a soliton-based signal from line 311 and a soliton-based signal from line 313 and transmits a summed or averaged signal comprising a single soliton to a receiver over signal line 317. In some embodiments, transmission line 313 is simply not used during transmission of a single soliton to the receiver.

The transmitter may alternatively transmit a soliton-resulting signal to each of transmission lines 311 and 313 with a predetermined delay between transmissions. Delay element 315 may be used to produce the predetermined delay. Circuit 316 then receives a soliton from line 311 and a delayed soliton from line 313 and transmits a solitonic molecule to a receiver over signal line 317.

In yet other embodiments, transmission line 320 comprises one or more instances of modified varactor 322. Varactor 322 may be controlled to selectively generate a soliton based on a signal from a transmitter or to generate a solitonic molecule based on such a signal. Varactor 322 may thereby selectively exhibit the aforementioned time-delay memory effect.

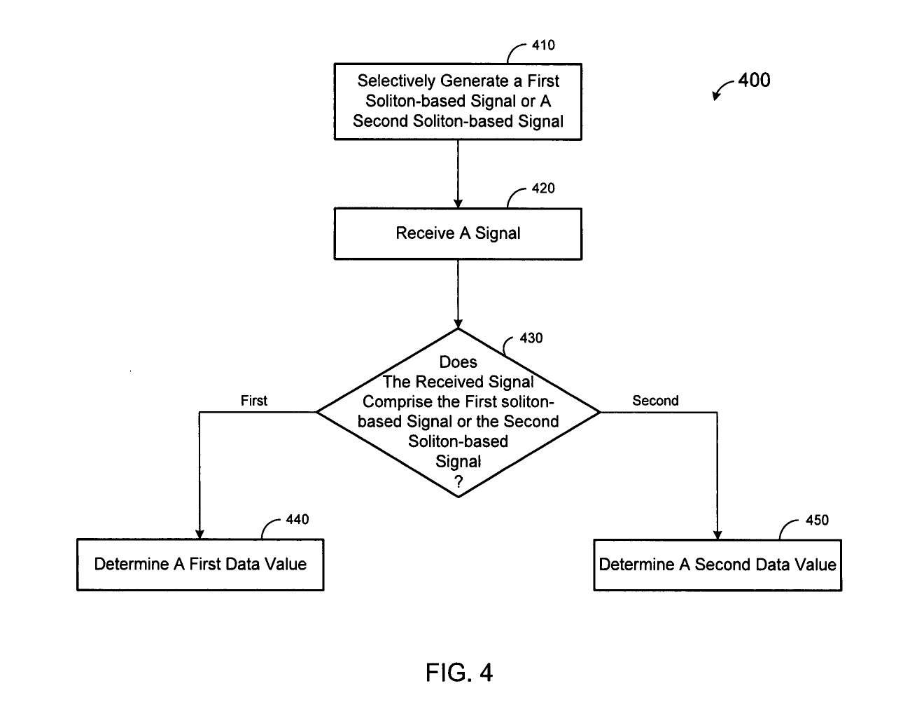

FIG. 4 is a diagram of process 400 according to some embodiments. Process 400 may be executed by any combination of hardware, software and/or firmware. Initially, at 410, a first soliton-based signal or a second soliton-based signal is selectively generated. According to some embodiments, the first soliton-based signal is generated if a first data value (e.g., “1”) is to be transmitted and the second soliton-based signal is generated if a second data value (e.g., “0”) is to be transmitted. In some examples of 410, transmission circuit 110 of FIG. 1 may generate a soliton in order to transmit a first data value or a solitonic molecule in order to transmit a second data value.

A signal is then received at 420, and it is determined whether the received signal comprises the first soliton-based signal or the second soliton-based signal. The received signal may be received at 420 by a receiver such as receiver 120. Determination of whether the received signal comprises the first soliton-based signal or the second soliton-based signal may comprise any currently- or hereafter-known system to detect and identify a waveform. For example, the receiver may comprise a differential amplifier designed to distinguish a soliton and a solitonic molecule based on one or more characteristics such as but not limited to a rise time, a total energy, and a pulse width.

Flow proceeds from 430 to 440 if the received signal is determined to comprise the first soliton-based signal. At 440, a first data value is determined based on the first soliton-based signal. For example, the receiver may determine at 440 that the received signal represents a binary “1”. Similarly, it may be determined at 450 that the received signal represents a binary “0” if the received signal is determined to comprise the second soliton-based signal at 430.

Some embodiments of the foregoing therefore provide distinct waveforms for two different symbols. As a result, determination of transmitted data values might not be affected by significant jitter in the arrival time of the corresponding waveforms. A complete code word may therefore be accurately received and loaded into data registers without employing clock recovery at the receiver.

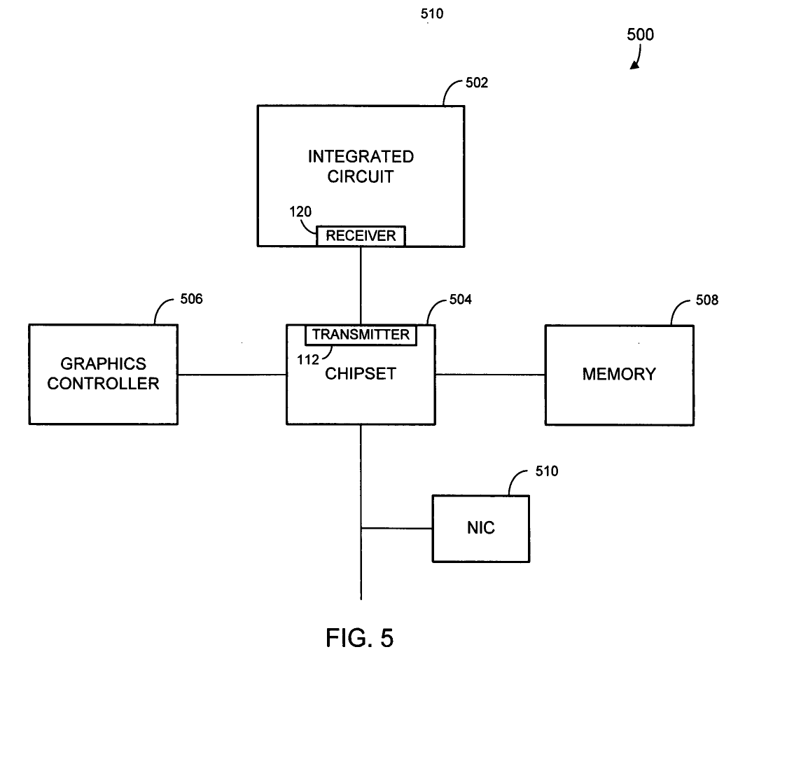

FIG. 5 is a block diagram of system 500 according to some embodiments. System 500 includes integrated circuit 502 comprising receiver 120 of FIG. 1. Integrated circuit 502 may be a microprocessor or another type of integrated circuit. Chipset 504 includes transmitter 112 for communicating with receiver 120 of integrated circuit 502. According to some embodiments, chipset 504 also communicates with graphics controller 506, memory 508, and Network Interface Controller (NIC) 510 via appropriate busses or ports. Memory 508 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

The several embodiments described herein are solely for the purpose of illustration. Therefore, persons in the art will recognize from this description that other embodiments may be practiced with various modifications and alterations.

What is claimed is:

1. A system comprising:
a transmission circuit to selectively generate a first soliton-based signal or a second soliton-based signal; and
a receiver to receive a first signal from the transmission circuit, to determine whether the first signal comprises the first soliton-based signal or the second soliton-based signal, and to determine a data value based on whether the received signal comprises the first soliton-based signal or the second soliton-based signal.

2. A system according to claim 1, wherein the first soliton-based signal is a soliton, and
wherein the second soliton-based signal is a solitonic molecule.

3. A system according to claim 1, wherein the transmission circuit comprises:
a transmitter; and
a non-linear transmission line.

4. A system according to claim 3, wherein the non-linear transmission line comprises:
a varactor comprising an input and an output; and
a signal line to selectively disconnect the input from the output in order to transmit a first data value or connect the input to the output in order to transmit a second data value.

5. A system according to claim 3, wherein the non-linear transmission line comprises:
a varactor to selectively generate a soliton in order to transmit a first data value or a solitonic molecule in order to transmit a second data value.

6. A system according to claim 1, wherein the transmission circuit comprises:
a transmitter;
a first non-linear transmission line coupled to the transmitter and to receive a second signal from the transmitter;
a second non-linear transmission line coupled to the transmitter and to receive the second signal from the transmitter; and
a circuit to receive a third signal from the first non-linear transmission line and a fourth signal from the second non-linear transmission line, and to generate the first signal based on the third signal and the fourth signal,
wherein the transmitter is to selectively transmit the second signal to the first non-linear transmission line and to the second non-linear transmission line substantially simultaneously in order to transmit a first data value or with a predetermined delay period therebetween in order to transmit a second data value.

7. A system according to claim 1, wherein the receiver is to determine whether the signal comprises the first soliton-based signal or the second soliton-based signal asynchronously.

8. A method comprising:
selectively generating a first soliton-based signal or a second soliton-based signal;
determining whether a received signal comprises the first soliton-based signal or the second soliton-based signal;
determining a data value based on whether the received signal comprises the first soliton-based signal or the second soliton-based signal.

9. A method according to claim 8, wherein the first soliton-based signal is a soliton, and
wherein the second soliton-based signal is a solitonic molecule.

10. A method according to claim 8, wherein selectively generating the first soliton-based signal or the second soliton-based signal comprises:
selectively disconnecting an input of a varactor from an output in order to transmit a first data value or connecting the input to the output in order to transmit a second data value.

11. A method according to claim 8, wherein selectively generating the first soliton-based signal or the second soliton-based comprises:
controlling a varactor to selectively generate a soliton in order to transmit a first data value or a solitonic molecule in order to transmit a second data value.

12. A method according to claim 8, wherein selectively generating the first soliton-based signal or the second soliton-based comprises:
transmitting a second signal to a first non-linear transmission line;
transmitting the second signal to a second non-linear transmission line substantially simultaneously with transmission of the second signal to the first non-linear transmission line in order to transmit a first data value or with a pretermined delay period therebetween in order to transmit a second data value;
receiving a third signal from the first non-linear transmission line and a fourth signal from the second non-linear transmission line; and
generating the received signal based on the third signal and the fourth signal.

13. A method according to claim 8, comprising:
determining whether the signal comprises the first soliton-based signal or the second soliton-based signal asynchronously.

14. A system comprising:
a transmission circuit to selectively generate a first soliton-based signal or a second soliton-based signal;
a microprocessor comprising a receiver to receive a first signal from the transmission circuit, to determine whether the first signal comprises the first soliton-based signal or the second soliton-based signal, and to determine a data value based on whether the received signal comprises the first soliton-based signal or the second soliton-based signal; and
a double data rate memory coupled to the microprocessor.

15. A system according to claim 14, wherein the first soliton-based signal is a soliton, and
wherein the second soliton-based signal is a solitonic molecule.

16. A system according to claim 14, wherein the transmission circuit comprises:
a non-linear transmission line comprising:
a varactor comprising an input and an output; and
a signal line to selectively disconnect the input from the output in order to transmit a first data value or connect the input to the output in order to transmit a second data value.

17. A system according to claim 14, wherein the transmission circuit comprises:
a non-linear transmission line comprising:
a varactor to selectively generate a soliton in order to transmit a first data value or a solitonic molecule in order to transmit a second data value.

18. A system according to claim 14, wherein the transmission circuit comprises:
a chipset;
a first non-linear transmission line coupled to the chipset and to receive a second signal from the chipset;
a second non-linear transmission line coupled to the chipset and to receive the second signal from the chipset; and
a circuit to receive a third signal from the first non-linear transmission line and a fourth signal from the second non-linear transmission line, and to generate the first signal based on the third signal and the fourth signal,
wherein the chipset is to selectively transmit the second signal to the first non-linear transmission line and to the second non-linear transmission line substantially simultaneously in order to transmit a first data value or with a predetermined delay period therebetween in order to transmit a second data value.

19. A system according to claim 14, wherein the receiver is to determine whether the signal comprises the first soliton-based signal or the second soliton-based signal asynchronously.
